(19) United States
(12) Patent Application Publication
(10) Pub. No.: US 2011/0061032 A1
(43) Pub. Date: Mar. 10, 2011

(54) HIGH-LEVEL SYNTHESIS APPARATUS, HIGH-LEVEL SYNTHESIS METHOD, AND COMPUTER READABLE MEDIUM COMPRISING HIGH-LEVEL SYNTHESIS PROGRAM

(75) Inventor: Yohei KOJIMA, Chiba-Shi (JP)

(73) Assignee: KABUSHIKI KAISHA TOSHIBA, Tokyo (JP)

(21) Appl. No.: 12/730,104

(22) Filed: Mar. 23, 2010

(30) Foreign Application Priority Data
Sep. 8, 2009 (JP) 2009-207458

(51) Int. Cl. G06F 17/50

(52) U.S. Cl. 716/104

(57) ABSTRACT

A high-level synthesis apparatus includes an input unit inputting a behavioral description indicating a behavior of a semiconductor integrated circuit comprising a plurality of functional units, an internal representation generator generating an internal representation based on the behavioral description, the internal representation showing a data flow in the behavioral description and an order in which operations are to be performed in the behavioral description, a scheduler performing scheduling for the operations in the internal representation generated in such a manner that non-operating cycles of the functional units continue, a binder performing binding for determining a configuration of the semiconductor integrated circuit operates scheduled operations on the internal representation generated, a circuit description generator generating a circuit description based on a scheduled result and a bound result, and an output unit outputting the internal representation and the circuit description.

### CROSS-REFERENCE TO RELATED APPLICATION

This application is based upon and claims the benefit of priority from the prior Japanese Patent Application No. 2009-207458, filed on Sep. 8, 2009; the entire contents of which are incorporated herein by reference.

### BACKGROUND OF THE INVENTION

1. Field of the Invention

The present invention relates to a high-level synthesis apparatus, a high-level synthesis method, and a computer readable medium comprising a high-level synthesis program and, specifically, those for use in design of a semiconductor integrated circuit.

2. Related Art

Recently, as a method for reducing a period for designing a large scale integration (LSI), a method is known for using a conventional high-level synthesis apparatus that generates a circuit description based on a behavioral description fed by user. The conventional high-level synthesis apparatus generates the circuit description in such a manner that one functional unit performs the same kind of operations in the behavioral description. In the conventional high-level synthesis apparatus, a relationship between what one functional unit performs a plurality of operations (hereinafter referred to as “share of functional unit”) and power consumption (hereinafter referred to as “dynamic power consumption”) in an operation of the LSI is not considered. That is, it is not considered which one of the functional units should be shared and in which cycles the functional unit should be shared, in order to efficiently reduce the dynamic power consumption. Therefore, the circuit description in such a manner that the functional unit is shared only when each of performance cycles does not overlap with other performance cycles is generated. As a result, such a circuit description in which the functional unit is used evenly over all the cycles would be generated.

On the other hand, a technology is known for turning off power to be supplied to each of gates in the functional unit in order to reduce not only the dynamic power consumption in the operation of the LSI but also power consumption (hereinafter referred to as “static power consumption”) in a non-operation of the LSI.

However, when the power is turned off, there is a problem in that as described above, the circuit description in which the functional unit is used evenly over all the cycles would be generated. Specifically, it is taken at least several microseconds to restore the power once turned off. Therefore, for the LSI operating in the cycle of several nanoseconds, it is required that the cycles in which the functional unit is not operating (hereinafter referred to as “non-operating cycle”) should be continual as long as possible. However, in the conventional high-level synthesis apparatus, the non-operating cycles will not be continual because the circuit description in which the functional unit is used evenly over all the cycles is generated. As a result, the LSI designed by utilizing the circuit description generated by the conventional high-level synthesis apparatus has a short turned-off time period of the power. That is, the conventional high-level synthesis apparatus cannot provide the user with information and the circuit description which are required to efficiently reduce the power consumption including the dynamic power consumption and the static power consumption.

Another technology (hereinafter referred to as “clock gating”) is known for stopping a clock signal to be supplied to each of the gates in the functional unit in order to save on the number of times to switch the gates, thereby reducing the dynamic power consumption ((see JP-A 2008-282360 (KOKAI)). In JP-A 2008-282360 (KOKAI), if there is a plurality of speculative executions under exclusive conditions, the clock signal to be supplied to a register that corresponds to the operations rendered unnecessary when performance conditions are determined is stopped, thereby reducing the dynamic power consumption of the LSI.

However, in JP-A 2008-282360 (KOKAI), it is impossible to reduce the power consumption when the performance conditions are not exclusive. Further, in recent years, with shrinkage of the LSI, the percentage of the static power consumption with respect to the dynamic power consumption is increased. Therefore, reducing only the dynamic power consumption is not enough to save the power consumption of the LSI. That is, even if a scheme of JP-A 2008-282360 (KOKAI) is applied to the conventional high-level synthesis apparatus, it is impossible to provide the user with information required to efficiently reduce the power consumption of the LSI.

### BRIEF SUMMARY OF THE INVENTION

According to a first aspect of the present invention, there is provided a high-level synthesis apparatus comprising:

an input unit configured to input a behavioral description indicating a behavior of a semiconductor integrated circuit comprising a plurality of functional units;

an internal representation generator configured to generate an internal representation based on the behavioral description input by the input unit, the internal representation showing a data flow in the behavioral description and an order in which operations are to be performed in the behavioral description;

a scheduler configured to perform scheduling for the operations in the internal representation generated by the internal representation generator in such a manner that non-operating cycles of the functional units continue;

a binder configured to perform binding for determining a configuration of the semiconductor integrated circuit operates scheduled operations on the internal representation generated by the internal representation generator;

a circuit description generator configured to generate a circuit description based on a result scheduled by the scheduler and a result bound by the binder; and

an output unit configured to output the internal representation generated by the internal representation generator and the circuit description generated by the circuit description generator.

According to a second aspect of the present invention, there is provided a high-level synthesis method comprising:

inputting a behavioral description indicating a behavior of a semiconductor integrated circuit comprising a plurality of functional units;

generating an internal representation based on the behavioral description, the internal representation showing a data flow in the behavioral description and an order in which operations are to be performed in the behavioral description;

performing scheduling for the operations in the internal representation in such a manner that non-operating cycles of the functional units continue;

performing binding for determining a configuration of the semiconductor integrated circuit operates scheduled operations on the internal representation;

generating a circuit description based on a scheduled result and a bound result; and

outputting the internal representation and the circuit description.

According to a third aspect of the present invention, there is provided a computer readable medium comprising a high-level synthesis program comprising:

inputting a behavioral description indicating a behavior of a semiconductor integrated circuit comprising a plurality of functional units;

generating an internal representation based on the behavioral description, the internal representation showing a data flow in the behavioral description and an order in which operations are to be performed in the behavioral description;

performing scheduling for the operations in the internal representation in such a manner that non-operating cycles of the functional units continue;

performing binding for determining a configuration of the semiconductor integrated circuit operates scheduled operations on the internal representation;

generating a circuit description based on a scheduled result and a bound result; and

outputting the internal representation and the circuit description.

### BRIEF DESCRIPTION OF THE DRAWINGS

FIG. 1 is a block diagram showing a configuration of a high-level synthesis apparatus 10 according to a first embodiment of the present invention.

FIG. 2 is a block diagram showing functions which are realized by a CPU 16 in FIG. 1.

FIG. 3 is a block diagram showing functions of a scheduler 162 in FIG. 2.

FIG. 4 is a flowchart showing a procedure of a high-level synthesis operation according to the first embodiment of the present invention.

FIG. 5 is a flowchart showing a procedure a scheduling step (S403) in FIG. 4.

FIG. 6 is a diagram of a comparative example between the first embodiment of the present invention and the conventional techniques.

FIG. 7 is a block diagram showing functions of a scheduler 162 according to the second embodiment of the present invention.

FIG. 8 is a flowchart showing a procedure of the scheduling step (S403) according to the second embodiment of the present invention.

FIG. 9 is a diagram of a specific example of a dividing step (S802) in FIG. 8.

FIG. 10 is a flowchart showing the procedure of a binding step (S404) according to the third embodiment of the present invention.

FIG. 11 is a diagram of the procedure in FIG. 10.

FIG. 12 is an outlined explanatory diagram of the specific example of the high-level synthesis operation according to the third embodiment of the present invention.

### DETAILED DESCRIPTION OF THE INVENTION

Hereafter, embodiments of the present invention will now be explained with reference to the accompanying drawings.

### First Embodiment

A first embodiment of the present invention will now be explained. The first embodiment is a basic example of a high-level synthetic apparatus according to the embodiments.

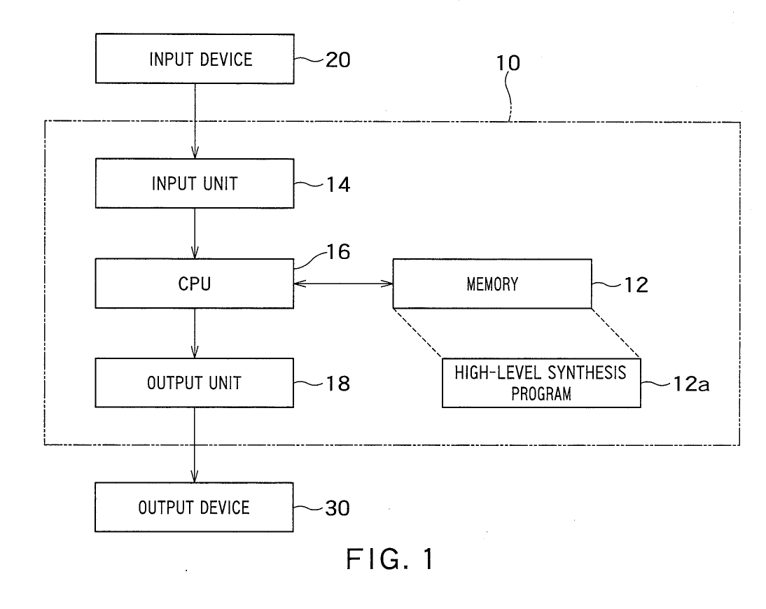

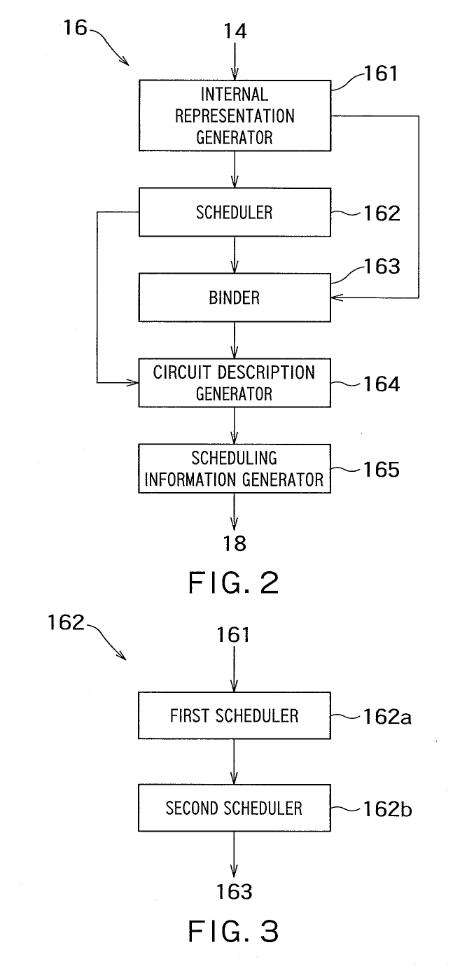

A configuration of the high-level synthetic apparatus according to the first embodiment will now be explained. FIG. 1 is a block diagram showing a configuration of a high-level synthesis apparatus 10 according to a first embodiment of the present invention. FIG. 2 is a block diagram showing functions which are realized by a CPU 16 in FIG. 1. FIG. 3 is a block diagram showing functions of a scheduler 162 in FIG. 2.

As shown in FIG. 1, a high-level synthesis apparatus 10 includes a memory 12, an input unit 14, a processor (hereinafter referred to as “central processing unit (CPU)”) 16, and an output unit 18. The CPU 16 is connected to the memory 12, the input unit 14, and the output unit 18. Input data to the high-level synthesis apparatus 10 includes a source code of a behavioral level description (hereinafter referred to as “behavioral description”) indicating a behavior of the semiconductor integrated circuit including a plurality of functional units. Output data from the high-level synthesis apparatus 10 includes a register transfer level (hereinafter referred to as “RTL”) description, a control data flow graph (CDFG) indicating a data flow and a control flow, and a high-level synthesis result including information regarding the share of the functional units.

The memory 12 in FIG. 1 stores a high-level synthesis program 12a configured to realize functions (see FIG. 2) of the CPU 16 to perform a high-level synthesis operation (described below) according to the first embodiment. Further, the memory 12 is configured to store a variety of data generated by the CPU 16 in the high-level synthesis operation.

The input unit 14 in FIG. 1 is connected to an input device 20. Further, the input unit 14 is configured to input the behavioral description fed by the user through the input device 20. For example, the input device 20 may be a keyboard or a network interface. If the input device 20 is the network interface, the input unit 14 inputs the behavioral description from a server (not shown) connected thereto via a network.

The CPU 16 in FIG. 1 is configured to start the high-level synthesis program 12a stored in the memory 12, thereby realizing functions necessary for the high-level synthesis operation, which include an internal representation generator 161, a scheduler 162, a binder 163, a circuit description generator 164, and a scheduling information generator 165 in FIG. 2.

The internal representation generator 161 in FIG. 2 is configured to generate an internal representation which indicates internal information of software, that is, a data flow in the behavioral description and an order in which the operations are to be performed in the behavioral description, based on the behavioral description input by the input unit 14. For example, the internal representation generator 161 analyzes the behavioral description, and generates the CDFG and the order based on analyzing results.

The scheduler 162 in FIG. 2 is configured to perform scheduling for the operations in the behavioral description, in which the timing of operations in such a manner that the non-operating cycles of the functional units continue is determined, on the internal representation generated by the internal representation generator 161. That is, the scheduler 162 performs the scheduling in such a manner that the performance cycles in which the same kind of operations is performed continue. As shown in FIG. 3, the scheduler 162 includes a first scheduler 162a and a second scheduler 162b. The first scheduler 162a performs first scheduling in such a manner that one functional unit performs the operations (that is, the functional unit is shared by the operations), on the internal representation generated by the internal representation generator 161. The second scheduler 162b performs second scheduling in such a manner that the non-operating cycles of the functional units continue, on the internal representation after the first scheduling is performed by the first scheduler 162a.

The binder 163 in FIG. 2 is configured to perform binding for determining a configuration of the semiconductor integrated circuit operating scheduled operations by the scheduler 162 based on results scheduled by the scheduler 162, on the internal representation generated by the internal representation generator 161.

The circuit description generator 164 in FIG. 2 is configured to generate the circuit description based on the results scheduled by the scheduler 162 and results bound by the binder 163. For example, the circuit description is an RTL description.

The scheduling information generator 165 in FIG. 2 is configured to generate scheduling information including timing information, domain information, increase information, and cycle information. The timing information indicates power-off timing and power-restoration timing. The domain information indicates power supply domains to which the functional unit and a register belong. The increase information indicates increased circuit volume in a circuit scale (for example, increased numbers of the functional units and the registers) in the circuit description in a case where the second scheduling is performed (that is, the high-level synthesis results according to the first embodiment) compared with the circuit description in a case where only the first scheduling is performed (that is, typical high-level synthesis results). The cycle information indicates the number of cycles in which power consumption is reduced.

The output unit 18 in FIG. 1 is connected to an output device 30. Further, the output unit 18 is configured to output the internal representation generated by the internal representation generator 161, the circuit description generated by the circuit description generator 164, and the scheduling information generated by the scheduling information generator 165. For example, the output device 30 is a display, a printer, or the network interface. If the output device 30 is the network interface, the output unit 18 outputs the internal representation, the circuit description, and the scheduling information to the server connected thereto via the network.

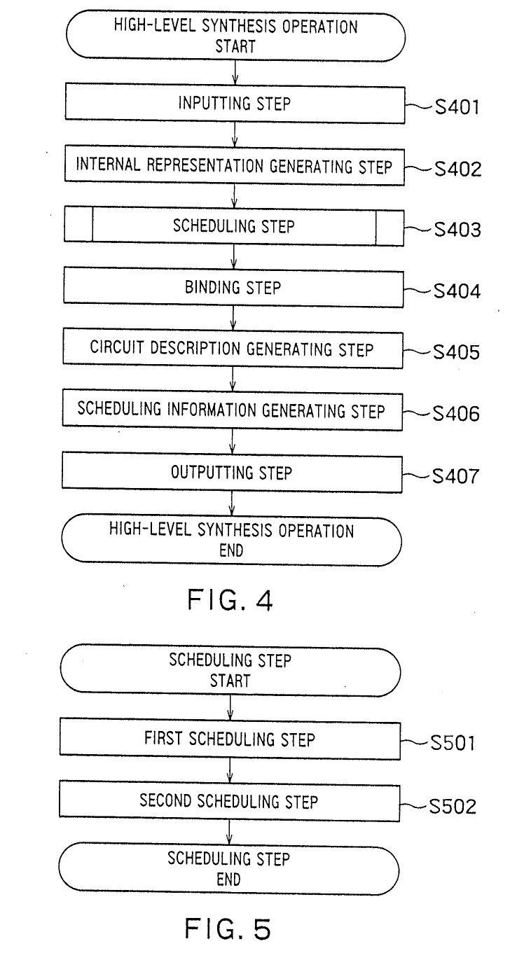

The high-level synthesis operation according to the first embodiment will now be explained. FIG. 4 is a flowchart showing a procedure of a high-level synthesis operation according to the first embodiment of the present invention. FIG. 5 is a flowchart showing a procedure a scheduling step (S403) in FIG. 4.

### FIG. 4: Inputting Step (S401)

The input unit 14 inputs the behavioral description fed by the user through the input device 20.

### FIG. 4: Internal Representation Generating Step (S402)

The internal representation generator 161 analyzes the source code of the behavioral description input in the inputting step (S401), thereby generating the CDFG.

### FIG. 4: Scheduling Step (S403)

The scheduler 162 performs the scheduling on the CDFG generated in the internal representation generating step (S402), thereby determining the timing of operations in such a manner that the non-operating cycles of the functional units continue. Specifically, the scheduling step (S403) will be performed according to a procedure shown in FIG. 5.

### FIG. 5: First Scheduling Step (S501)

The first scheduler 162a performs the first scheduling in such a manner that one functional unit performs the operations, on the CDFG generated in the internal representation generating step (S402). The first scheduling step (S501) will be performed by a typical method.

### FIG. 5: Second Scheduling Step (S502)

The second scheduler 162b performs the second scheduling in such a manner that the non-operating cycles of the functional units continue, on the CDFG after the first scheduling is performed in the first scheduling step (S501). For example, the second scheduler 162b selects one of the operations having other operations close-packed before and after themselves, based on first results scheduled in the first scheduling step (S501), which are represented in the CDFG. Then, the second scheduler 162b performs the scheduling in such a manner that other operations become near a clock step in which the selected operations are scheduled.

The second scheduling step (S502) is followed by a binding step (S404) in FIG. 4.

### FIG. 4: Binding Step (S404)

The binder 163 performs the binding in such a manner that the functional units are allocated to the operations based on the results scheduled in the scheduling step (S403) (that is, second results scheduled in the second scheduling step (S502)). The binding step (S404) will be performed by a typical method.

### FIG. 4: Circuit Description Generating Step (S405)

The circuit description generator 164 generates the RTL description based on the results scheduled in the scheduling step (S403) and the results bound in the binding step (S404). In the circuit description generating step (S405), a signal indicating an on-state/off-state for each of power supply domains every states of a state machine may be generated. Further, in the circuit description generating step (S405), although the RTL description including descriptions which indicates a control circuit for a power saving operation (described below) is not generated, the RTL description including information which indicates a timing when the power saving operation for each of power supply domains can be performed may be generated.

### FIG. 4: Scheduling Information Generating Step (S406)

The second scheduling information generator 165 generates the scheduling information based on the second results scheduled in the second scheduling step (S502). The scheduling information includes the timing information, the domain information, the increase information, and the cycle information.

### FIG. 4: Outputting Step (S407)

The output unit 18 outputs the output device 30 with the results (CDFG after the second scheduling step (S502) is performed by the second scheduler 162b) scheduled in the scheduling step (S403), the results (RTL description corresponding to the second results scheduled in the second scheduling step (S502)) in the circuit description generating step (S405), and the scheduling information (the timing information, the domain information, the increase information, and the cycle information) generated in the scheduling information generating step (S406).

After the outputting step (S407), the high-level synthesis operation ends.

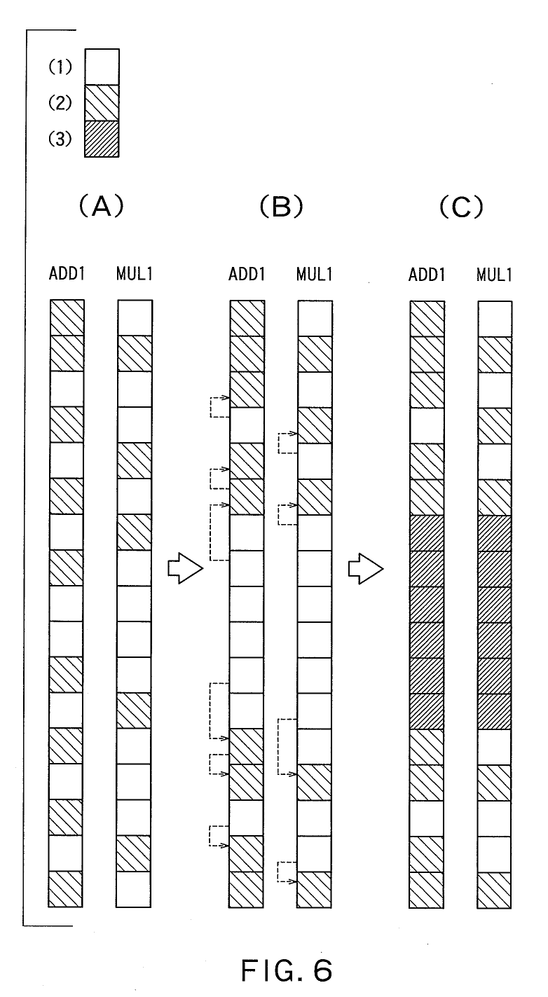

A comparative example between the first embodiment and the conventional techniques will now be explained. FIG. 6 is a diagram of a comparative example between the first embodiment of the present invention and the conventional techniques.

In (A) of FIG. 6, conventional high-level synthesis results are shown. As shown in (A) of FIG. 6, in the conventional high-level synthesis results, the non-operating cycles ((1) in (A) to (C) of FIG. 6) and cycles (hereinafter referred to as “operating cycles”) in which the functional units operate ((2) in (A) to (C) of FIG. 6) are formed without biases. In this case, it is impossible to secure a time period long enough to perform an operation (hereinafter referred to as “power saving operation”) to cut off and restore the power supplied to the functional units in the non-operating cycles. Therefore, the power consumption of the LSI cannot be efficiently reduced.

In (B) and (C) of FIG. 6, high-level synthesis results according to the first embodiment are shown. As shown in (B) of FIG. 6, in the high-level synthesis operation according to the first embodiment, continual non-operating cycles are formed. In this case, as shown in (C) of FIG. 6, as long as the non-operating cycle is long enough to perform the power saving operation, the continual non-operating cycles can be used as a cycle (hereinafter referred to as “power saving operation cycle”) ((3) in (A) to (C) of FIG. 6) for the power saving operation. Therefore, the power consumption of the LSI can be efficiently reduced. That is, the high-level synthesis results in (C) of FIG. 6, which are required to reduce the power consumption of the LSI more efficiently than the case of using the conventional high-level synthesis results in (A) of FIG. 6, can be obtained.

(C) of FIG. 6 shows an example where an adder ADD1 and a multiplier MUL1 belong to the same power supply domain. However, the scope of the present invention is not limited to the example. In the first embodiment, the power saving operation may be performed on the functional units which belong to the different power supply domains each other. In this case, it is possible to cut off the power supplied to the multiplier MUL1 in (C) of FIG. 6 until a further next cycle. That is, amount of reduced power consumption of the LSI by performing the power saving operation on the functional units belonging to the different power supply domains each other is higher than that by performing the power saving operation on the functional units belonging to the same power supply domain. The functional units and the state machine which are impossible to be cut off the power belong to the power supply domain to which the power is always supplied.

According to the first embodiment, the scheduler 162 performs the scheduling in which the timing of operations in such a manner that the non-operating cycles of the functional units continue is determined. Then, the output unit 18 outputs the high-level synthesis results based on the scheduled results. Therefore, information required to efficiently reduce the power consumption of the LSI can be easily obtained. Further, a working efficiency is improved on downstream manufacturing steps for the power saving operation.

Further, according to the first embodiment, the scheduler 162 includes the second scheduler 162b that performs the second scheduling in such a manner that the non-operating cycles of the functional units continue, on the internal representation after the first scheduling is performed. Therefore, the high-level synthesis results can be obtained, which have continual non-operating cycles.

In the first embodiment, the output unit 18 may output only the internal representation and the circuit description. In this case, the scheduling information generator 165 will be omitted.

Further, in the first embodiment, the output unit 18 may output only the timing information and the domain information contained in the scheduling information generated by the scheduling information generator 165. In this case, the scheduling information generator 165 will not generate the increase information and the cycle information.

Further, although the first embodiment has been explained with the example where the power is cut off and restored in the power saving operation, the scope of the present invention is not limited to the example. In the first embodiment, the power saving operation may employ the clock gating in the non-operating cycles. In this case, the continual non-operating cycles are formed by the second scheduler 162b. Therefore, an ENABLE signal for use in the clock gating can be easily controlled.

### Second Embodiment

A second embodiment of the present invention will now be explained. The second embodiment is an example of a high-level synthesis apparatus that performs the scheduling on each of CDFGs which are divided (hereinafter referred to as “divided CDFG”). A description of the same contents as the above-described embodiment will be omitted.

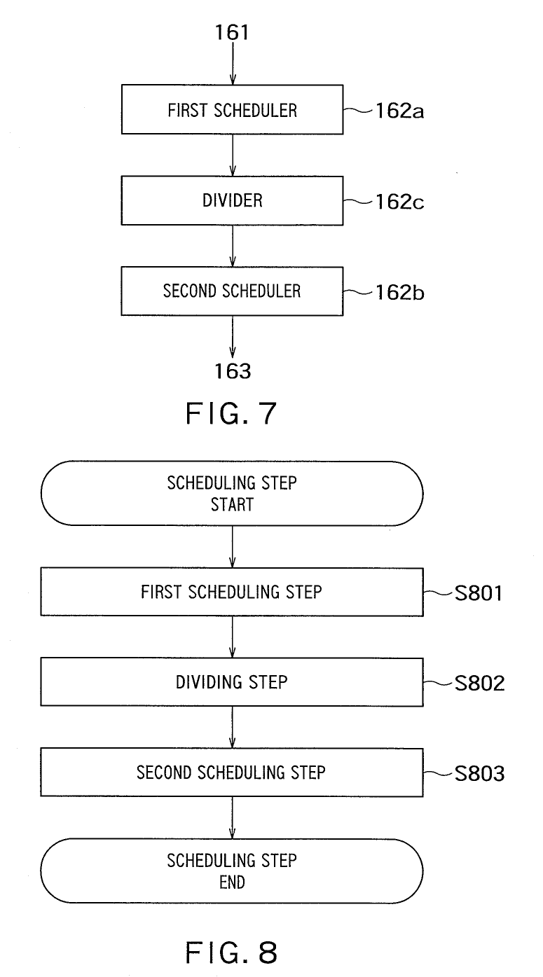

A configuration of a high-level synthesis apparatus according to the second embodiment will now be explained. FIG. 7 is a block diagram showing functions of a scheduler 162 according to the second embodiment of the present invention.

As shown in FIG. 7, the scheduler 162 includes the first scheduler 162a, the second scheduler 162b, and a divider 162c. The first scheduler 162a is the same as that according to the first embodiment.

The divider 162c in FIG. 7 is configured to divide the internal representation after the first scheduling is performed by the first scheduler 162a into a plurality of divided internal representations.

The second scheduler 162b in FIG. 7 is configured to perform the second scheduling based on each of the divided internal representations.

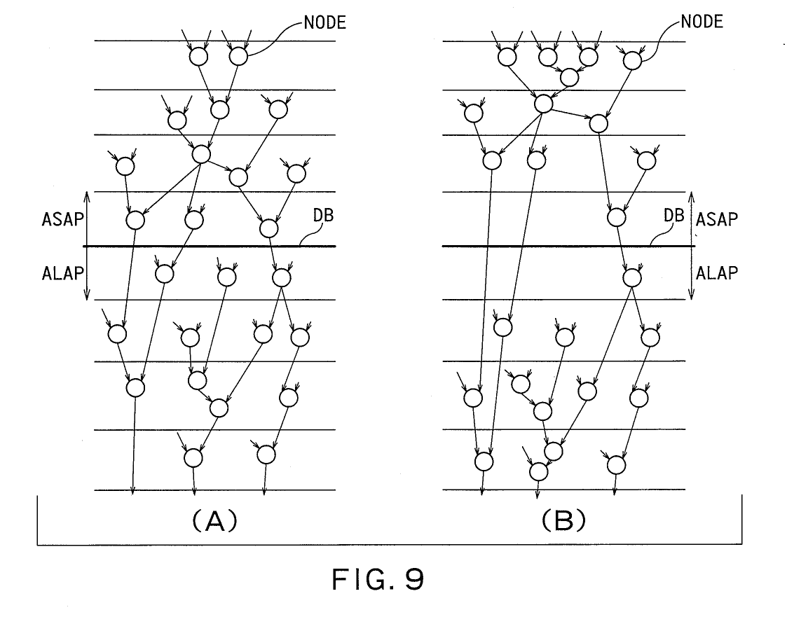

A high-level synthesis operation according to the second embodiment will now be explained. FIG. 8 is a flowchart showing a procedure of the scheduling step (S403) according to the second embodiment of the present invention. FIG. 9 is a diagram of a specific example of a dividing step (S802) in FIG. 8.

### FIG. 8: First Scheduling Step (S801)

This step is the same as the first scheduling step (S501) in FIG. 5.

### FIG. 8: Dividing Step (S802)

The divider 162c divides the CDFG generated in the first scheduling step (S801) into a plurality of divided CDFGs. For example, as shown in (A) in FIG. 9, a branch across a dividing borderline DB is handled as output data above the dividing borderline DB and handled as input data below the dividing borderline DB. That is, the divided CDFGs at a previous stage of the dividing borderline DB and the divided CDFGs at a subsequent stage of the dividing borderline DB are handled independently of each other. As a result, in the second scheduling step (S803) (described below), continual non-operating cycles are generated easily. FIG. 9 shows an example where the CDFG is divided into two the divided CDFGs by setting the center of all the cycles to be performed to the dividing borderline DB.

### FIG. 8: Second Scheduling Step (S803)

The second scheduler 162b performs the second scheduling on each of the divided CDFGs in such a manner that the cycles in which the same kind of operations is performed continue as much as possible. For example, in the divided CDFGs at the previous stage of the dividing borderline DB, scheduling is performed in such a manner that operations are performed as soon as possible (that is, the operating cycles continue from an earlier cycle), while in the divided CDFGs at the subsequent stage of the dividing borderline DB, scheduling is performed in such a manner that operations are performed as late as possible (that is, the operating cycles continue from a later cycle). In other words, the second scheduler 162b performs the second scheduling in such a manner that the operating cycles are allocated to positions away from the dividing borderline DB. As a result, as shown in (B) of FIG. 9, performing the operations will not be allocated around the dividing borderline DB between the divided internal representations (that is, the non-operating cycles will be continual).

The second scheduling step (S803) is followed by the binding step (S404) in FIG. 4. In the binding step (S404) according to the second embodiment, the binder 163 interconnects the branches of each of the divided CDFGs with each other, which are once separated from each other, thereby the plurality of divided CDFGs is merged into one CDFG.

In the second embodiment, the number of divided CDFGs is not limited to two. Further, in the second embodiment, the input unit 14 may input the number of divided CDFGs and the position of the dividing borderline DB fed by the user.

According to the second embodiment, the second scheduler 162b performs the second scheduling on each of the divided CDFGs. Therefore, information required to reduce the power consumption of the LSI more efficiently than the first embodiment can be easily obtained. Further, the working efficiency on the downstream manufacturing steps for the power saving operation is higher than that according to the first embodiment.

In the second embodiment, the second scheduler 162b may perform the second scheduling in such a manner that the power saving operation cycle is prolonged as much as possible with in a predetermined number of functional units. The number of functional units may be determined on the basis of information input by the input unit 14. Therefore, information regarding an appropriate number of functional units, which is required to efficiently reduce the power consumption of the LSI, can be easily obtained.

### Third Embodiment

A third embodiment of the present invention will now be explained. The third embodiment is an example of a high-level synthesis apparatus that cancels the share of the functional units when a period of time necessary in the power saving operation is not secured for the high-level synthesis results. A description of the same contents as the above-described embodiments will be omitted.

A configuration of a high-level synthesis apparatus according to the third embodiment will now be explained with reference to FIG. 2. The internal representation generator 161, the scheduler 162, the circuit description generator 164, and the scheduling information generator 165 in FIG. 2 are the same as those in the second embodiment, respectively.

The binder 163 in FIG. 2 is configured to perform the binding on the second results scheduled by the second scheduler 162b. In the binding, a new functional unit is allocated to share-cancelled operations when the non-operating cycles necessary in the power saving operation are secured by cancelling the share of functional unit.

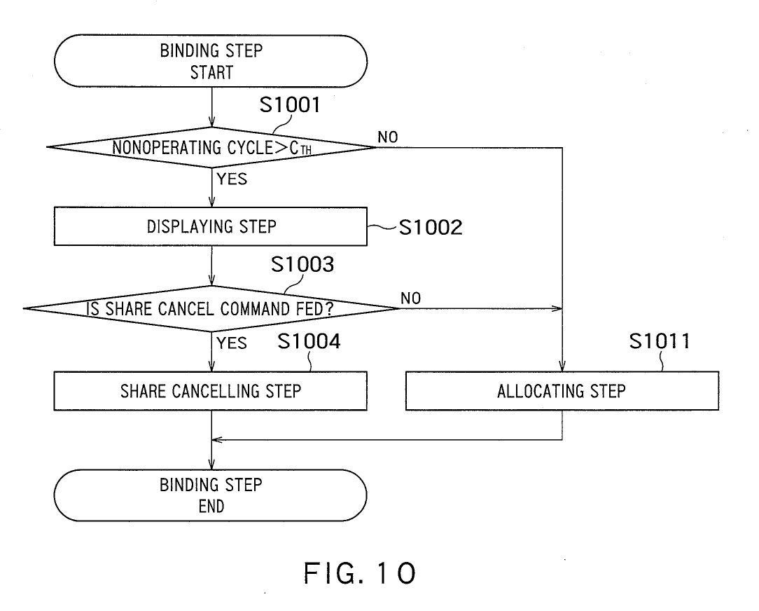

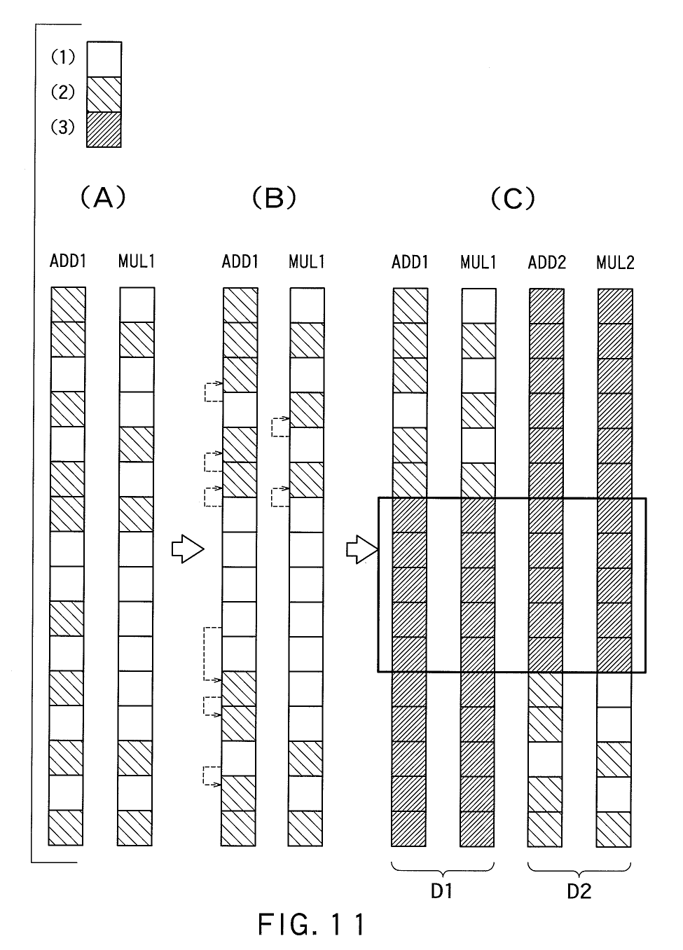

A high-level synthesis operation according to the third embodiment will now be explained. FIG. 10 is a flowchart showing the procedure of a binding step (S404) according to the third embodiment of the present invention. FIG. 11 is a diagram of the procedure in FIG. 10.

### FIG. 10: S1001

The binder 163 determines a magnitude relation between the number of non-operating cycles and a predetermined share cancelling threshold C_{TH}. The share cancelling threshold C_{TH} is input by the input unit 14 and used as an index in deciding whether the share of functional unit should be canceled for the power saving operation. When the number of non-operating cycles is larger than the share cancelling threshold C_{TH} (YES in S1001), the procedure advances to a displaying step (S1002). When the number of non-operating cycles is not larger than the share cancelling threshold C_{TH} (NO in S1001), the procedure advances to an allocating step (S1011). For example, in a case where results of the second scheduled results shown in (B) of FIG. 11 are obtained from the first scheduled results shown in (A) of FIG. 11, the procedure advances to the displaying step (S1002) when it is determined that the number of continual non-operating cycles ((1) in (A) to (C) of FIG. 11) is larger than the share cancelling threshold C_{TH} (YES in S1001), even if the number of continual non-operating cycles is not long enough to perform the power saving operation.

### FIG. 10: Displaying Step (S1002)

An output unit 18 outputs the output device 30 with two messages regarding the high-level synthesis results obtained when the second scheduling is performed. One message indicates that the number of non-operating cycles is larger than the share cancelling threshold C_{TH}. For example, the message includes the number of non-operating cycles and the number of cycles necessary in the power saving operation. Another message is a confirmation message as for whether a share cancelling step (S1004) (described below) should be performed. In response to it, the user will feed a command as for whether the share cancelling step (S1004) should be performed through the input device 20. The command fed by the user will be input by the input unit 14, and supplied to the binder 163.

### FIG. 10: S1003

When the user feeds the command for the share cancelling step (S1004) (hereinafter referred to as “share cancelling command”) (YES in S1003), a procedure advances to the share cancelling step (S1004). When the user does not feed the share cancelling command (NO in S1003), a procedure advances to the allocating step (S1011).

### FIG. 10: Share Cancelling Step (S1004)

The binder 163 cancels the share of functional unit and allocates new functional units to those operations to which no functional units is allocated. For example, as shown in (C) of FIG. 11, an adder ADD1 and a multiplier MUL1 which belong to a power supply domain D1 as well as an adder ADD2 and a multiplier MUL2 which belong to a power supply domain D2 are allocated to the operations which are performed by the adder ADD1 and the multiplexer MUL1 in (B) of FIG. 11. As a result, the number of power saving operation cycles ((3) in (C) of FIG. 11) is increased, and a sufficient number of power saving operation cycles (that is, cycles in which the power supplied to the two power supply domains D1 and D2 is cut off) are secured for all of the functional units (the adders ADD1 and ADD2 as well as the multipliers MUL1 and MUL2).

### FIG. 10: Allocating Step (S1011)

The binder 163 allocates the functional units to the operations based on the results scheduled by the scheduler 162. The allocating step (S1011) will be performed by a typical method.

The share cancelling step (S1004) or the allocating step (S1011) is followed by the circuit description generating step (S405) in FIG. 4.

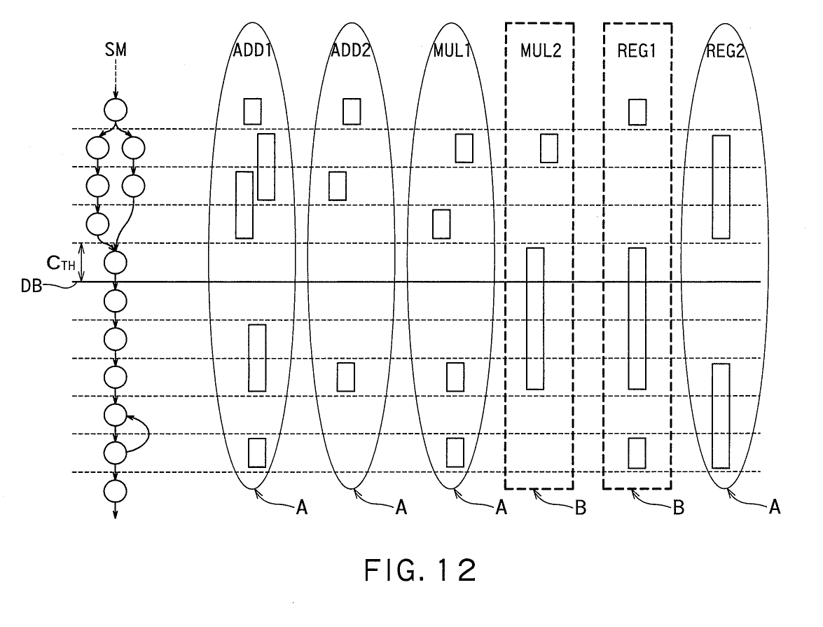

A specific example of a high-level synthesis operation according to the third embodiment will now be explained. FIG. 12 is an outlined explanatory diagram of the specific example of the high-level synthesis operation according to the third embodiment of the present invention.

FIG. 12 shows a register life time and a status of use of the functional units in an example case. In the example case, the second scheduling is performed over again by the second scheduler 162b on the CDFG across the dividing borderline DB and the binding is performed on the CDFG. As a result, the non-operating cycles have became continual for the CDFG across the dividing borderline DB. A rectangle for each of functional units ADD1, ADD2, MUL1, and MUL2 as well as registers REG1 and REG2 indicates which state of a state machine SM each of them is used in.

The binder 163 determines the functional units and the registers which are handled in the share cancelling step (S1004), based on the share cancelling threshold C_{TH}. The share cancelling threshold C_{TH} indicates a minimum number of secured non-operating cycles counted from the dividing borderline DB, which is required to perform the share cancelling step (S1004).

In ellipsoids A in FIG. 12, as for the adders ADD1 and ADD2, the multiplier MUL1, and the register REG2, the non-operating cycles more than the share cancelling threshold C_{TH} are across the dividing borderline DB. Therefore, the share cancelling step (S1004) is performed on those functional units. As a result, some of the operations are cancelled of the share of functional unit. Then, the same kind of functional units are allocated to the operations in which the share of functional unit is cancelled. In this case, the different functional units (those belonging to the different power supply domains) are allocated respectively to the operations performed in the divided CDFGs at the previous stage of the dividing borderline DB and at the subsequent stage of the dividing borderline DB before the share of functional unit is cancelled.

On the other hand, in broken-line rectangles B in FIG. 12, as for the multiplier MUL2 and the register REG1, non-operating cycles more than the share cancelling threshold C_{TH} are nothing (that is, there is an operating cycle in the range of the share cancelling threshold C_{TH} as measured from the dividing borderline DB). Therefore, in place of the share cancelling step (S1004), the allocating step (S1011) is performed. In this case, the multiplier MUL2 and the register REG1 will belong to the power supply domain of steady supply of power similar to the power supply domain to which the state machine SM belongs.

The share cancelling threshold C_{TH} need not be the same value both in the divided CDFGs at the previous stage and at the subsequent stage of the dividing borderline DB. Further, the share cancelling threshold C_{TH} may be specified in only either one of the divided CDFGs at the previous stage and at the subsequent stage.

According to the third embodiment, when the non-operating cycles necessary in the power saving operation are secured, the binder 163 cancels the share of functional unit and allocates functional units belonging to the different power supply domain to the share-cancelled functional unit. Specifically, the binder 163 cancels the share of functional unit for which the non-operating cycles necessary in the power saving operation are secured. Then, the binder 163 allocates the functional units belonging to the different power supply domains to the operations respectively in the divided CDFGs at the previous stage of the dividing borderline DB and at the subsequent stage of the dividing borderline DB, which should be performed by those share-cancelled functional units. Therefore, as for the functional units which are used only in the divided CDFG at the previous stage, a time period from a cycle which is behind the dividing borderline DB by the share cancelling threshold C_{TH} to a cycle in which a whole operation ends is given for the power saving operation. On the other hand, as for the functional units which are used only in the divided CDFG at the subsequent stage, a time period from a cycle in which the whole operation starts to a cycle which is behind the dividing borderline DB by the share cancelling threshold C_{TH} is given for the power saving operation. Resultantly, a sufficient lapse of time necessary for the power saving operation can be secured. In (C) of FIG. 11, although the circuit scale increases due to the share cancelling step (S1004), the time period for the power saving operation is secured in both of the power supply domains D1 and D2. Therefore, the power consumption and the dissipation energy are reduced significantly. As the share cancelling threshold C_{TH} increases, the numbers of the functional units and the registers which are handled in the share cancelling step (S1004) are decreased but the number of power saving operation cycles necessary for the share cancelling step (S1004) is increased.

In the third embodiment, step S1001 may be performed on the basis of a plurality of share cancelling thresholds C_{TH} in such a manner that the number of power saving operation cycles becomes maximized.

At least a portion of the high-level synthesis apparatus 10 according to the above-described embodiments of the present invention may be composed of hardware or software. When at least a portion of the high-level synthesis apparatus 10 is composed of software, a program for executing at least some functions of the high-level synthesis apparatus 10 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the high-level synthesis apparatus 10 according to the above-described embodiment of the present invention may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

The above-described embodiments of the present invention are just illustrative, but the invention is not limited thereto. The technical scope of the invention is defined by the appended claims, and various changes and modifications of the invention can be made within the scope and meaning equivalent to the claims.

What is claimed is:

1. A high-level circuit synthesis apparatus comprising:
an input module configured to input a behavioral description indicating a behavior of a semiconductor integrated circuit comprising a plurality of circuit elements;
an internal representation generator configured to generate an internal representation based on the behavioral description, the internal representation showing a data flow in the behavioral description and an order to execute operations in the behavioral description;
a scheduler configured to schedule the operations in the generated internal representation in such a manner that continuous groupings of non-operating cycles of the circuit elements are preferred over discontinuous groupings of non-operating cycles of the circuit elements;
a binder configured to bind a configuration of the semiconductor integrated circuit configured to operate the scheduled operations based on the generated internal representation;
a circuit description generator configured to generate a circuit description based on a result scheduled by the scheduler and a result bound by the binder; and
an output module configured to output the generated internal representation and the generated circuit description.

2. The apparatus of claim 1, wherein the scheduler comprises:
a first scheduler configured to execute a first scheduling on the generated internal representation in such a manner that one of the circuit elements is shared by a plurality of operations; and
a second scheduler configured to execute a second scheduling on the internal representation after the first scheduling in such a manner that continuous groupings of the non-operating cycles are preferred over discontinuous groupings of non-operating cycles of the circuit elements.

3. The apparatus of claim 2, wherein
the scheduler further comprises a divider configured to divide the internal representation after the first scheduling into a plurality of divided internal representations, and
the second scheduler is configured to execute the second scheduling on the divided internal representations.

4. The apparatus of claim 3, wherein the second scheduler is configured to execute the second scheduling in such a manner that continuous groupings of the non-operating cycles across a borderline between two divided internal representations are preferred over discontinuous groupings of non-operating cycles across the borderline between the two divided internal representations.

5. The apparatus of claim 4, wherein the second scheduler is configured to execute the second scheduling on a previous divided internal representation of the two divided internal representations in such a manner that continuous groupings of operating cycles from an earlier cycle are preferred over discontinuous groupings of operating cycles from the earlier cycle, and to execute the second scheduling on a subsequent divided internal representation of the two divided internal representations in such a manner that continuous groupings of operating cycles from a later cycle are preferred over discontinuous groupings of operating cycles from the later cycle.

6. The apparatus of claim 2, wherein the binder is configured to cancel sharing the circuit elements on the result scheduled by the scheduler and allocate a new circuit elements to the plurality of operations when the non-operating cycles for a power saving operation are not allocated.

7. The apparatus of claim 1, further comprising a scheduling information generator configured to generate scheduling information comprising timing information and domain information, the timing information indicating power-off timing and power-restoration timing, the domain information indicating the circuit elements and registers corresponding to power supply domains, wherein
the output module is further configured to output the generated scheduling information.

8. The apparatus of claim 7, wherein the scheduling information generator is configured to generate the scheduling information further comprising increase information and cycle information, the increase information indicating an increased circuit volume in a circuit scale in the circuit description when the second scheduling is executed compared with the circuit description when only the first scheduling is executed, the cycle information indicating the number of cycles with reduced power consumption.

9. A high-level synthesis method comprising:
inputting a behavioral description indicating a behavior of a semiconductor integrated circuit comprising a plurality of circuit elements;
generating an internal representation based on the behavioral description, the internal representation indicating a data flow in the behavioral description and an order to execute operations in the behavioral description;
scheduling the operations in the internal expression in such a manner that continuous groupings of non-operating cycles of the circuit elements are preferred over discontinuous groupings of non-operating cycles of the circuit elements;
binding a configuration of the semiconductor integrated circuit configured to operate the scheduled operations on the internal representation;
generating a circuit description based on a scheduled result and a bound result; and
outputting the internal representation and the circuit description.

10. The method of claim 9, further comprising a first scheduling on the internal representation in such a manner that one of the circuit elements is shared by a plurality of operations, and a second scheduling on the internal representation after the first scheduling in such a manner that continuous groupings of the non-operating cycles are preferred over discontinuous groupings of non-operating cycles of the circuit elements.

11. The method of claim 10, wherein the internal representation after the first scheduling is divided into a plurality of divided internal representations, and the second scheduling is executed on the divided internal representations.

12. The method of claim 11, wherein the second scheduling is executed in such a manner that continuous groupings of the non-operating cycles across a borderline between two divided internal representations are preferred over discontinuous groupings of non-operating cycles across the borderline between the two divided internal representations.

13. The method of claim 12, wherein the second scheduling on a previous divided internal representation of the two divided internal representations is executed in such a manner that continuous groupings of operating cycles from an earlier cycle are preferred over discontinuous groupings of operating cycles from the earlier cycle, and the second scheduling on a subsequent divided internal representation of the two divided internal representations is executed in such a manner that continuous groupings of operating cycles from a later cycle are preferred over discontinuous groupings of operating cycles from the later cycle.

14. The method of claim 10, wherein sharing the circuit elements on the scheduled result is cancelled and a new circuit elements is allocated to the plurality of operations in the binding, when the non-operating cycles for a power saving operation are not allocated.

15. The method of claim 9, further comprising:
generating scheduling information comprising timing information and domain information, the timing information indicating power-off timing and power-restoration timing, the domain information indicating the circuit elements and registers corresponding to power supply domains; and
outputting the generated scheduling information with the internal representation and the circuit description.

16. The method of claim 15, wherein the scheduling information further comprising increase information and cycle information is generated, the increase information indicating an increased circuit volume in a circuit scale in the circuit description when the second scheduling is executed compared with the circuit description when only the first scheduling is executed, the cycle information indicating the number of cycles with reduced power consumption.

17. A computer readable medium having stored thereon a high-level synthesis program, that when executed by the one or more processors, causes the one or more processor to:
input a behavioral description indicating a behavior of a semiconductor integrated circuit comprising a plurality of circuit elements;
generate an internal representation based on the behavioral description, the internal representation indicating a data flow in the behavioral description and an order to execute operations in the behavioral description;
schedule the operations in the internal representation in such a manner that continuous groupings of non-operating cycles of the circuit elements are preferred over discontinuous groupings of non-operating cycles of the circuit elements;
bind configuration of the semiconductor integrated circuit configured to operate the scheduled operations on the internal representation;
generate a circuit description based on a scheduled result and a bound result; and
output the internal representation and the circuit description.

18. The medium of claim 17, wherein the program is additionally configured to cause the one or more processors to:
schedule on the internal representation in such a manner that one of the circuit elements is shared by a plurality of operations; and
schedule on the internal representation in such a manner that continuous groupings of the non-operating cycles are preferred over discontinuous groupings of non-operating cycles.

19. The medium of claim 18, wherein the program is additionally configured to cause the one or more processors to:
divide the internal representation after the first scheduling into a plurality of divided internal representations; and
schedule on the divided internal representations in such a manner that continuous groupings of the non-operating cycles are preferred over discontinuous groupings of non-operating cycles.

20. The medium of claim 19, wherein the program is additionally configured to cause the one or more processors to:
schedule in such a manner that continuous groupings of the non-operating cycles across a borderline between two divided internal representations are preferred over discontinuous groupings of non-operating cycles across the borderline between the two divided internal representations.
